(19) United States
(12) Patent Application Publication
(10) Pub. No.: US 2010/0135043 A1
(43) Pub. Date: Jun. 3, 2010

(54) COMPOSITE LIGHT GUIDING CURVED SURFACE STRUCTURE

(75) Inventors: LON WANG, Taipei City (TW); CHIH-SHENG JAO, Taoyuan County (TW); JER-HAUR CHANG, Changhua County (TW); YUNG-PIN CHEN, Tainan City (TW); HSIN-CHIEH CHIU, Taipei (TW)

Correspondence Address: WPAT, PC;INTELLECTUAL PROPERTY ATTORNEYS, 7225 BEVERLY ST., ANNANDALE, VA, 22003, US

(73) Assignee: National Taiwan University, Taipei (TW)

(21) Appl. No.: 12/578,712

(22) Filed: Oct. 14, 2009

(30) Foreign Application Priority Data
Nov. 28, 2008 (TW) 097146136

(51) Int. Cl. F21V 8/00; F21V 5/04

(52) U.S. Cl. 362/628; 362/311.06

(57) ABSTRACT

The present invention provides a composite light guiding curved surface structure, comprising a structure body and at least one light source. The structure body comprises a light-receiving surface being provided with a plurality of curved surfaces formed thereon, each of which being provided with a plurality of micro lenses. Each micro lens is further provided with a plurality of sub-wavelength anti-reflecting structures. The sub-wavelength anti-reflecting structures also cover the entire curved surface among lenses. At least one light source is disposed on one side of the light-receiving surface to generate a light field projecting to each of the curved surfaces on the light-receiving surface. In the present invention, the micro lens is capable of increasing the diffusing angle for light diffusion; meanwhile, the sub-wavelength anti-reflecting structures are capable of increasing the light transmission efficiency to reduce loss of light at the interface and enhance the utilization of light.

### BACKGROUND OF THE INVENTION

1. Field of the Invention

The present invention generally relates to a light guiding structure and, more particularly, to a composite light guiding curved surface structure capable of increasing the diffusing angle and the light-receiving efficiency.

2. Description of the Prior Art

The currently available LED back light is from point light sources and is less uniform as compared to line light sources such as the conventional cold cathode fluorescent lamp (CCFL). It is difficult to deformed light from point light sources into light from line light sources and thus light source mechanisms for uniformizing light are required. Therefore, it has become a key topic in the light guide plate industry to deform light from point light sources into more uniform light from line light sources and to further deform the light into light from a surface light source.

In a conventional liquid crystal display (LCD), the back light module uses cold cathode fluorescent lamps (CCFL) as light sources. However, the CCFL back light module has disadvantages such as short lifetime, large size, lower light-emitting efficiency than LED's and the use of environment-unfriendly mercury-vapor lamps, and has been thus replaced gradually by the LED back light module with less power consumption, smaller size, and environment-friendliness.

More particularly, the LED back light module exhibits higher light-emitting efficiency, more saturate colors and longer duration than the conventional CCFL back light module. According to Restrictions on Hazardous Substance (RoHs) that has been valid in European Union (EU) since July 2006, the LCD having a CCFL back light module using mercury-vapor lamps is restricted. Therefore, it has become a trend to replace the CCFL back light module by the LED back light module.

For the problem of non-uniform distribution of light from point light sources due non-uniform light intensity on the light-receiving end in the LED back light module, there have been reports on the design of V-grooved micro gratings on the light-receiving end to overcome the problem of non-uniform light intensity on the light-receiving end in the edge-type LED back light module.

For example, in U.S. Patent Pub. No. 20040130880, a light guide plate having a saw-toothed shaped light-receiving end is used in an edge-type LED back light module. The gratings provide multiple scattering and refraction to change the local orientation of the LED light source. Moreover, the pattern on the reflecting surface of a light guide plate can be designed to achieve uniform incoming light. In Japanese Patent Laid-Open Application No. 2007226075, micro lenses are provided on the pattern on the light guide plate to improve uniformity of light from the light source. Moreover, in U.S. Patent Pub. No. 20030058382, light uniformity is improved by designing asymmetric gratings with different pitches on the pattern on a reflecting surface of a light guide plate.

In U.S. Pat. No. 7,251,412, a phase function is applied on a surface used as a light-emitting surface of a light guide plate to enhance light uniformity. Moreover, in U.S. Patent Pub. No. 20040130879, the angle of light from the LED's is enlarged by an optical lens and a cylindrical surface is used as the light-receiving surface to overcome the problems due to non-uniformity of light.

Alternatively, the light-receiving surface of the light guide plate can be polished. In the literature, there has not been any report on reflection loss on the Fresnel interface. In order to reduce the reflection loss on the light-receiving surface, an anti-reflection layer is provided by coating.

However, there are only a few materials for coating and multi-layered coating takes time and is costly. Therefore, it is not suitable for back light modules manufactured by mass production.

### SUMMARY OF THE INVENTION

It is an object of the present invention to provide a composite light guiding curved surface structure by forming a plurality of micro lenses like a biomimetic compound eye structure on a structure body so that light from point light sources can be deformed into light from line light sources. Moreover, each of the micro lenses is provided with a plurality of anti-reflecting structures to increase the light transmission efficiency to reduce loss of light at the interface and enhance the utilization of light.

In one embodiment, the present invention provides a composite light guiding curved surface structure, comprising: a structure body comprising a light-receiving surface being provided with a plurality of curved surfaces thereon, each curved surface being provided with a plurality of micro lenses thereon, each micro lens being provided with a plurality of sub-wavelength anti-reflecting structures thereon; and at least one light source disposed on one side of the light-receiving surface to generate a light field projecting onto the light-receiving surface.

Preferably, the structure body is a direct-type light guide plate, an edge-type light guide plate or an edge-type light guide bar.

Preferably, the micro lens is a micro lens, preferably having an arc-surfaced structure, a cone-surfaced structure or combination thereof.

Preferably, the sub-wavelength anti-reflecting structures are arranged in an array.

Preferably, the sub-wavelength anti-reflecting structures are arranged irregularly.

Preferably, the sub-wavelength anti-reflecting structures are gratings, holes, columns, cones or combination thereof.

Preferably, the composite light guiding curved surface structure further comprises a light-emitting surface being provided with a plurality of micro structures, preferably being gratings.

### BRIEF DESCRIPTION OF THE DRAWINGS

The objects and spirits of various embodiments of the present invention will be readily understood by the accompanying drawings and detailed descriptions, wherein:

FIG. 1A is a schematic diagram of a composite light guiding curved surface structure according to one embodiment of the present invention;

FIG. 1B schematically shows the diffusing angle of light from a curved surface and a light source;

FIG. 2A to FIG. 2C are cross-sectional diagrams of micro lenses according to the present invention;

FIG. 3A to FIG. 3B are examples of cone-surfaced structures;

FIG. 4 is a schematic diagram showing micro lenses arranged irregularly according to the present invention;

FIG. 5 is a schematic diagram showing how light is refracted while traveling in different media;

FIG. 6A to FIG. 6C are schematic diagrams showing sub-wavelength anti-reflecting structures on a micro lens according to the present invention;

FIG. 7 is a schematic diagram of a composite light guiding curved surface structure according to another embodiment of the present invention;

FIG. 8A to FIG. 8C are schematic diagrams of a composite light guiding curved surface structure according to another embodiment of the present invention;

FIG. 9A and FIG. 9B schematically show the diffusing angle on a curved surface with and without the micro lenses, respectively; and

FIG. 10 schematically shows the vertical and horizontal diffusing angles on a curved surface with and without the micro lenses.

### DETAILED DESCRIPTION OF THE PREFERRED EMBODIMENT

The present invention can be exemplified but not limited by the embodiments as described hereinafter.

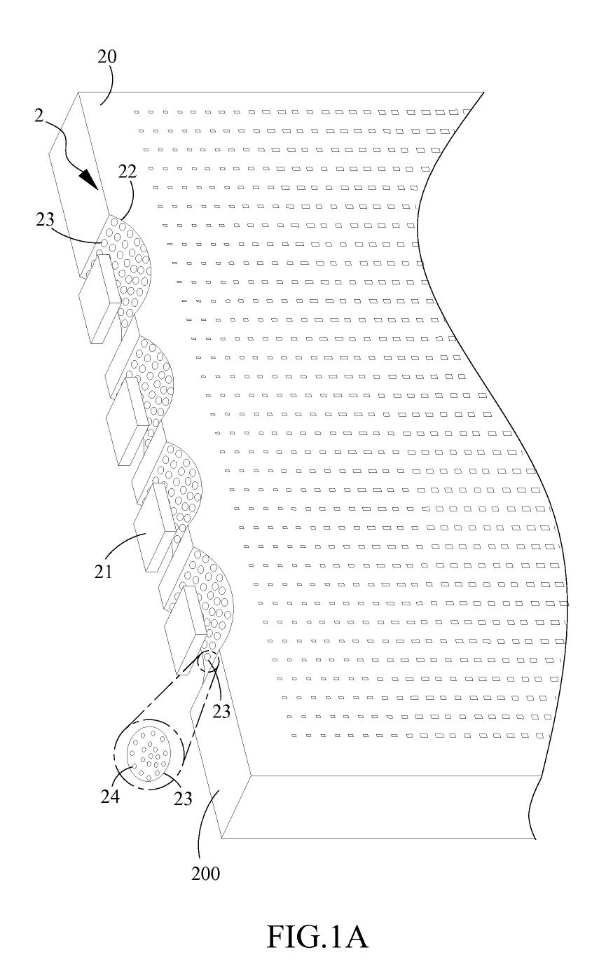

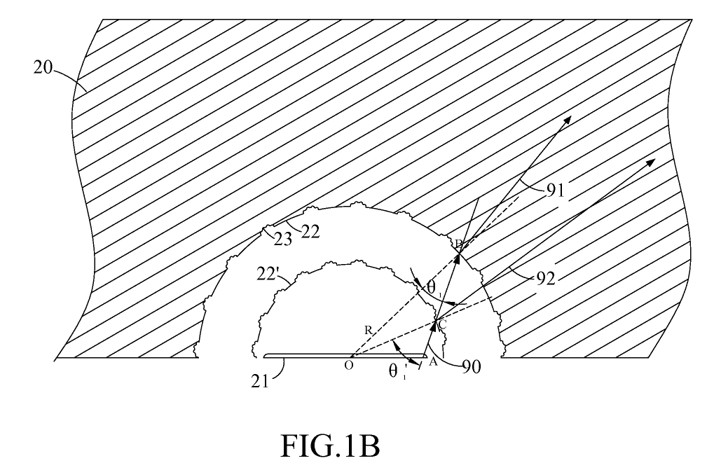

Please refer to FIG. 1A, which is a schematic diagram of a composite light guiding curved surface structure according to one embodiment of the present invention. In the present embodiment, the composite light guiding curved surface structure 2 comprises a structure body 20 and at least one light source 21. The structure body 20 is an edge-type light guide plate, which is provided with a light-receiving surface 200 thereon. The light-receiving surface 200 is provided with a plurality of curved surfaces 22 thereon. At least one light source 21 is disposed on one side of the light-receiving surface 200. In the present embodiment, a light source 21 is disposed on an outer surface of each curved surface 22. However, the present invention is not limited thereto. In other words, the number of light sources 21 can be different from the number of the curved surfaces 22 and be determined as is required. Each light source 21 is a point light source capable of generating a light field projecting onto a corresponding curved surface 22. In the present embodiment, each light source 21 is a LED.

As the radius of curvature of each curved surface 22 approaches the size of the light source 21, the diffusing angle of light entering the curved surface 22 becomes larger. As shown in FIG. 1B, the diffusing angle of light from a curved surface and a light source is schematically shown. According to the sine law, the triangle OAB meets formula (1) expressed as:

$$\frac{Sin {θ}_{1}}{\overline{AO}} = \frac{Sin ∠ OAB}{\overline{OB}} \qquad ( 1 )$$

wherein ∠OAB denotes the light-emitting angle of the light source 21, A̅O̅ is one half of the size of the light source 21, and O̅B̅ is the radius of curvature of the curved surface 22. According to the sine law in formula (1), when O̅B̅ gets smaller and the radius of curvature of the curved surface 22 approaches the size of the light source 21, the ratio of Sin θ₁ to A̅O̅ increases. Since A̅O̅ is constant, Sin θ₁ increases as O̅B̅ decreases. Therefore, in FIG. 1B, Sin θ₁ is smaller than Sin θ₁. Since the radius of curvature of the curved surface 22 is larger than that of the curved surface 22′, the diffusing angle of the reflected light beam 91 when the incident light beam 90 is reflected by the curved surface 22 is larger than the diffusing angle of the reflected light beam 92 when the incident light beam 90 is reflected by the curved surface 22′.

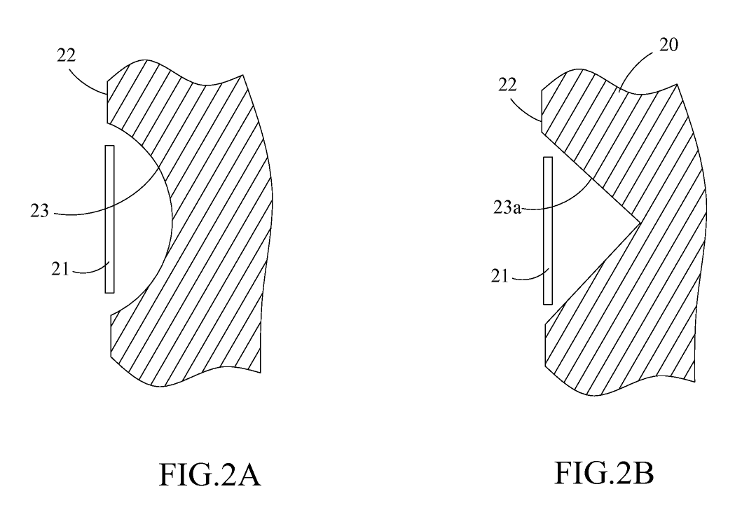

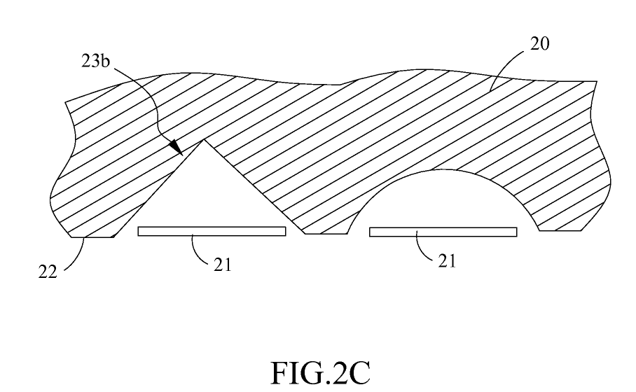

Referring to FIG. 1A, each curved surface 22 is provided with a plurality of micro lenses 23 thereon. As shown in FIG. 2A, a cross-sectional diagram of a micro lens according to the present invention is shown. In the present embodiment, the micro lens 23 has an arc-surfaced structure. Moreover, as shown in FIG. 2B, the micro lens 23a has a cone-surfaced structure. Moreover, as shown in FIG. 2C, the micro lens 23b has both an arc-surfaced structure and a cone-surfaced structure.

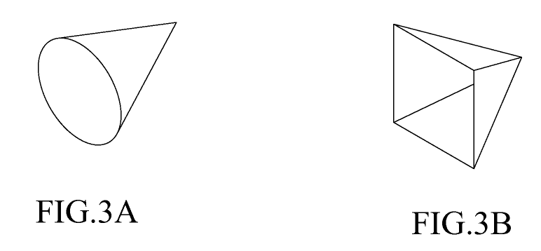

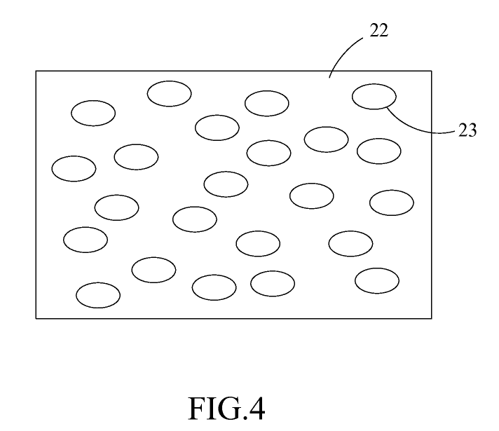

FIG. 3A to FIG. 3B are examples of cone-surfaced structures being circular or polygonal. In the embodiment in FIG. 1A, the micro lenses are arranged in an array on the curved surface. In addition, as shown in FIG. 4, the micro lenses 23 are arranged irregularly on the curved surface 22.

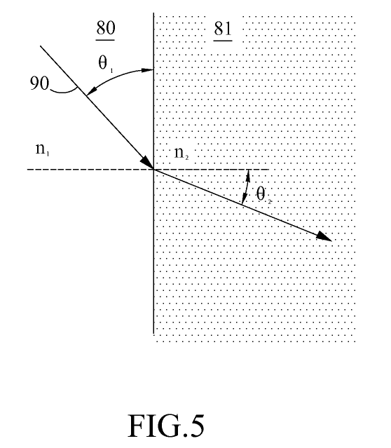

The micro lenses 23 are formed on each curved surface 22 like a biomimetic compound eye structure to increase the diffusing angle of the incident light beam for light diffusion. In non-imaging optics, the micro lenses 23 are formed to achieve multiple scattering and refraction of light from a point light source to increase the diffusing angle of the incident light beam according to Snell's Law, as expressed in formula (2) and FIG. 5.

$$\frac{sin {θ}_{1}}{sin {θ}_{2}} = \frac{{V}_{1}}{{V}_{2}} = \frac{{n}_{2}}{{n}_{1}} or {n}_{1} sin {θ}_{1} = {n}_{2} sin {θ}_{2} \qquad ( 2 )$$

wherein θ₁ is an incident angle of light 90 traveling from the medium 80 into the medium 81, θ₂ is a refraction angle of light 90 into the medium 81, V₁ and V₂ are velocity of light in the medium 80 and the medium 81 respectively, and n₁ and n₂ are the refraction index of the medium 80 and the medium 81.

If the composite light guiding curved surface structure is formed of a material without absorptivity, the light can be traced according to Fresnel equation in formula (3).

$${R}_{s} = {[ \frac{sin ( {θ}_{t} - {θ}_{i} )}{sin ( {θ}_{t} + {θ}_{i} )} ]}^{2} = {[ \frac{{n}_{1} cos ( {θ}_{i} ) - {n}_{2} cos ( {θ}_{t} )}{{n}_{1} cos ( {θ}_{i} ) + {n}_{2} cos ( {θ}_{t} )} ]}^{2} {T}_{s} = 1 - {R}_{s} \\ {R}_{p} = {[ \frac{tan ( {θ}_{t} - {θ}_{i} )}{tan ( {θ}_{t} + {θ}_{i} )} ]}^{2} = {[ \frac{{n}_{1} cos ( {θ}_{t} ) - {n}_{2} cos ( {θ}_{i} )}{{n}_{1} cos ( {θ}_{t} ) + {n}_{2} cos ( {θ}_{i} )} ]}^{2} {T}_{p} = 1 - {R}_{p} \qquad ( 3 )$$

wherein R and T represent the reflectivity and the transmitivity, respectively, s denotes TE Polarization, and p denotes TM Polarization. θᵢ equals θ₁; and θₜ equals θ₂.

Non-planar light can be traced according to formula (4). Since it requires a great amount of optical ray tracing calculation, non-sequential Monte Carlo ray tracing is used. If necessary, the currently available geometric optic ray tracing software such as Lightool, Tracepro, ASAP, SPEOS can be used. Such optical ray tracing software is well-known and thus description thereof is not presented.

$$cos {θ}_{1} = V \cdot P \\ cos {θ}_{2} = \sqrt{1 - {( \frac{{n}_{1}}{{n}_{2}} )}^{2} ( 1 - {( cos {θ}_{1} )}^{2} )} \\ {V}_{reflect} = V - ( 2 cos {θ}_{1} ) P \\ {V}_{refract} = ( \frac{{n}_{1}}{{n}_{2}} ) V + ( cos {θ}_{2} - \frac{{n}_{1}}{{n}_{2}} cos {θ}_{1} ) P \qquad ( 4 )$$

wherein V is a unit vector of light and P is a unit normal vector to a tangential surface where light is incident on the light guide plate.

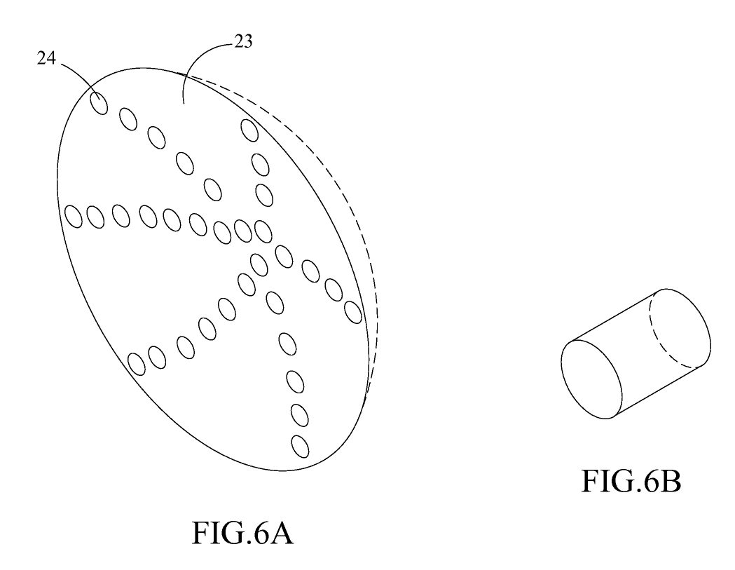

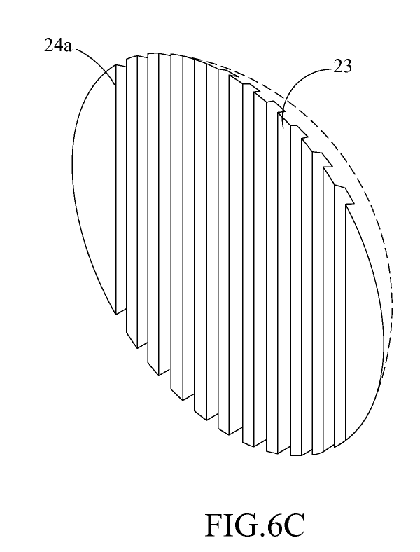

As shown in FIG. 6A, the micro lens 23 is provided with a plurality of sub-wavelength anti-reflecting structures 24 thereon to increase the light-receiving efficiency and light coupling efficiency. Compared to conventional anti-reflecting coating, the sub-wavelength anti-reflecting structure provides anti-reflection and wider bandwidth and is not material-limited, which is suitable for the back light module made by mass production. The sub-wavelength structures 24 can be arranged in an array or irregularly on the micro lens 23. The sub-wavelength anti-reflecting structures 24 can be curved surfaces as shown in FIG. 6A, column structures in FIG. 6B, cone structures in FIG. 3A and FIG. 3B or combination thereof. Moreover, as shown in FIG. 6C, in the present embodiment, gratings are formed on the micro lens 23 as the sub-wavelength anti-reflecting structures 24a. The anti-reflection theory will be described hereinafter. When the size of the surfaced structures approaches the wavelength of light, diffraction takes place. According to diffraction of gratings as expressed in formula (5):

$${n}_{t} sin {θ}_{m} = {n}_{i} sin {θ}_{i} + \frac{m λ}{Λ} \qquad ( 5 )$$

wherein nᵢ and nₜ denote the refraction index of media wherein light is incoming and transmitting, respectively; θᵢ and θₘ denote the incident angle and the m^{th} order diffraction angle; λ is the incident light wavelength; and A is the period of the grating. Since the size of the sub-wavelength anti-reflecting structures 24 is much shorter than the wavelength of electro-magnetic wave, higher order diffraction does not take place and only zero-order reflection and transmission happen when the electro-magnetic wave is incident on the sub-wavelength anti-reflecting structures 24. Therefore, only zero-order reflection elimination requires to be considered instead of complicated higher order diffraction.

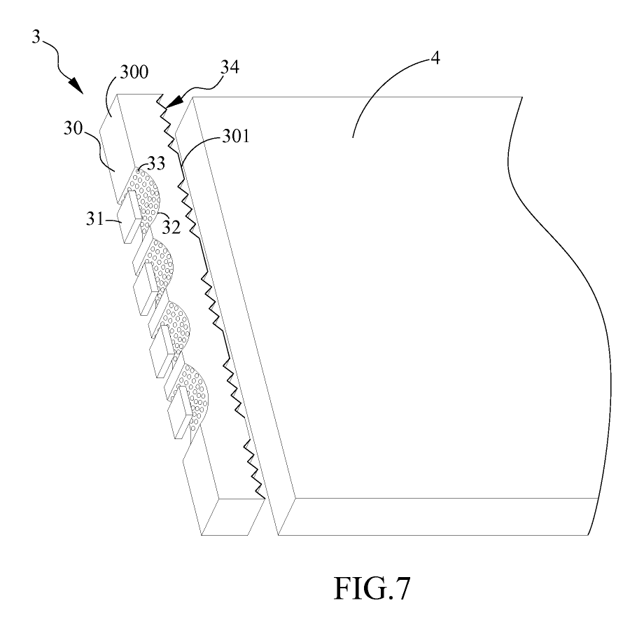

Please refer to FIG. 7, which is a schematic diagram of a composite light guiding curved surface structure according to another embodiment of the present invention. In the present embodiment, the composite light guiding curved surface structure is similar to the structure in FIG. 1 except that the composite light guiding curved surface structure 3 comprises a structure body 30 being a light guide bar disposed on one side of the light guide plate 4. Moreover, the composite light guiding curved surface structure 3 comprises a light-receiving surface 300 being provided with a plurality of curved surfaces 32 thereon, each curved surface 32 corresponding to a light source 31. The curved surface 32 is provided with a plurality of micro lenses 33 being arranged in an array or irregularly. Each micro lens 33 is further provided with a plurality of sub-wavelength anti-reflecting structures (not shown). The curved surfaces 32, the micro lenses 3 and the sub-wavelength anti-reflecting structures have been described above and thus descriptions thereof are not presented. In the present embodiment, on the light-emitting surface 301 corresponding to one side of the light-receiving surface 300, there are provided a plurality of gratings 34 with period and structure being determined as is required. In the present embodiment, the gratings 34 are saw-toothed shaped, but not limited thereto. In the present embodiment, the orientation of the light field from a light source can be changed by the micro structures and the anti-reflecting structures so that light from point light sources can be deformed into light from a line light source. The grating 34 are disposed so that light uniformity can be further improved by the composite light guiding curved surface structure 3. By adjusting the period and shape of the gratings 34, light from point light sources can be deformed into more uniform light as from a line light source. The structure of the gratings is well-known and thus description thereof is not presented herein.

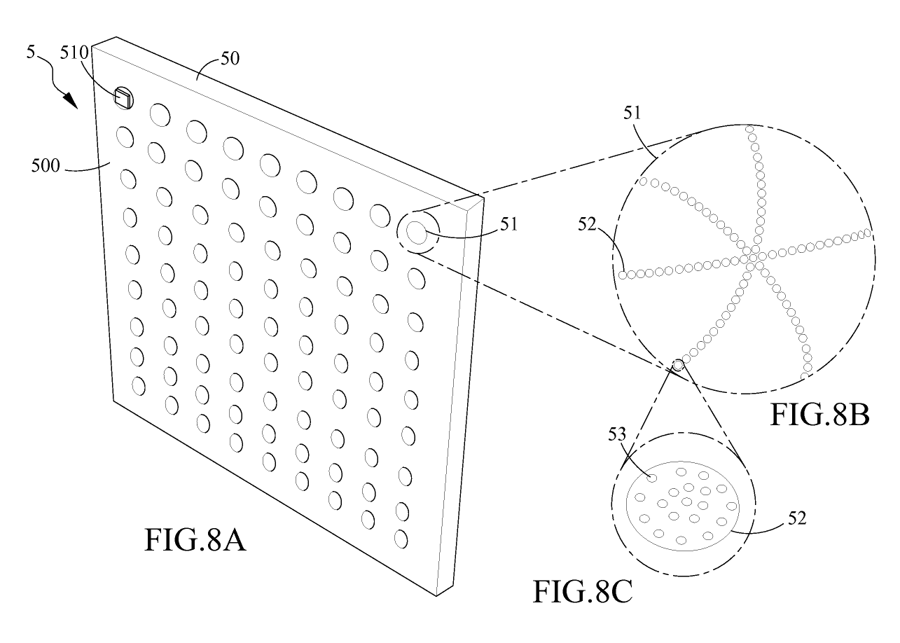

Please refer to FIG. 8A to FIG. 8C, which are schematic diagrams of a composite light guiding curved surface structure according to another embodiment of the present invention. In the present embodiment, the composite light guiding curved surface structure 5 is a direct-type composite light guiding curved surface structure. In other words, the composite light guiding curved surface structure 5 comprises a light-receiving surface 500 being a bottom surface of the composite light guiding curved surface structure 5, instead of being a side surface in FIG. 1. Essentially, the light-receiving surface 500 is provided with a plurality of curved surfaces 51 thereon. Each curved surface 51 corresponds to a light source 510 (only a light source being shown in the figure), for example, a light-emitting diode. Certainly, a plurality of curved surfaces 51 can also correspond to a light-emitting diode. As shown in FIG. 8B, each curved surface 51 is provided with a plurality of micro lenses 52 thereon. Each micro lens 52 is further provided with a plurality of sub-wavelength anti-reflecting structures 53, as shown in FIG. 6A. The curved surfaces 51, the micro lenses 52 and the curved surfaces 53 have been descried as above, and thus descriptions thereof are not presented herein.

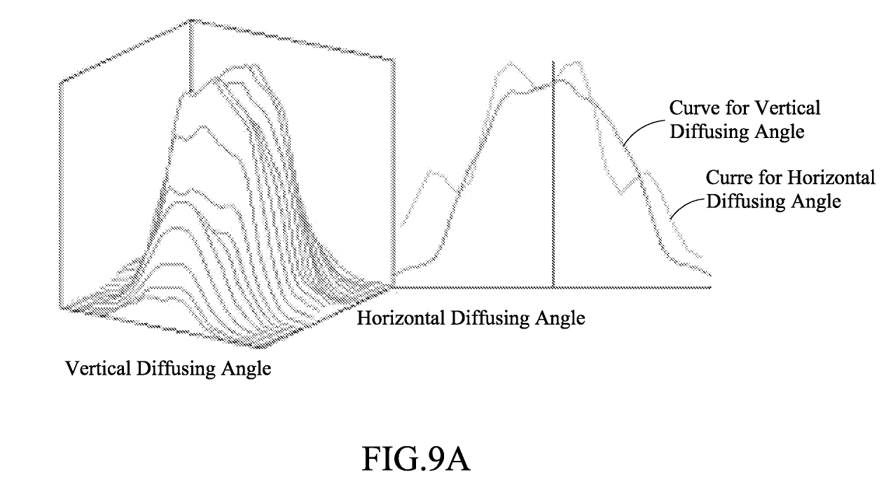

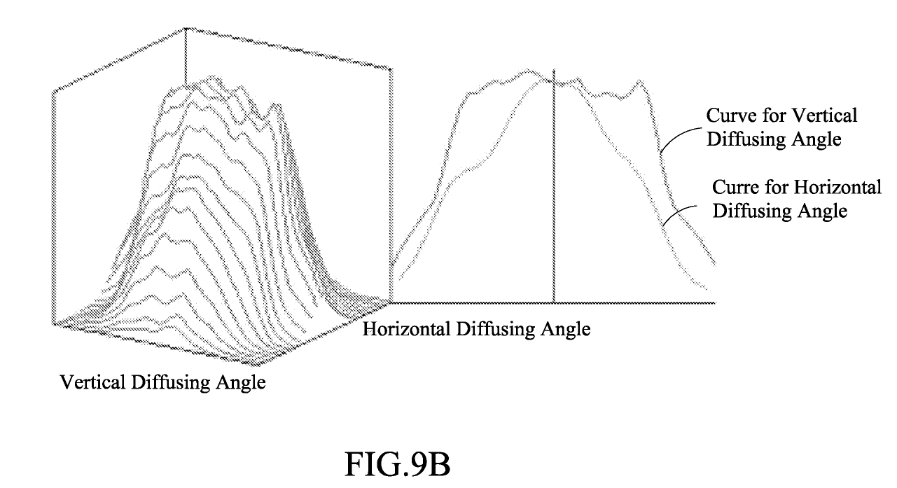

Please refer to FIG. 9A and FIG. 9B, which schematically show the diffusing angle on a curved surface with and without the micro lenses, respectively. By using optical ray tracing, the graph can be simulated. It is observed that the curve in FIG. 9B is more broadened than the curve in FIG. 9B since there are no micro structures in FIG. 9A and there are micro structures provided in FIG. 9B.

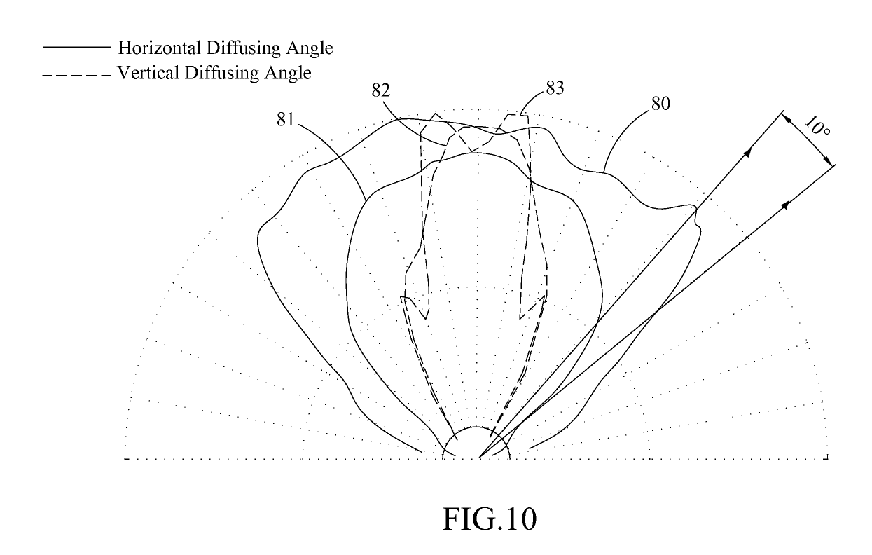

FIG. 10 schematically shows the vertical and horizontal diffusing angles on a curved surface with and without the micro lenses. Curve 80 represents a horizontal diffusing angle curve with micro lenses in the present invention. Curve 81 represents a horizontal diffusing angle curve without micro lenses. Curve 82 represents a vertical diffusing angle curve with micro lenses in the present invention. Curve 83 represents a vertical diffusing angle curve without micro lenses. In FIG. 10, it is observed that the present invention uses micro lenses so that the horizontal diffusing angle with micro lenses is 10 degrees larger than the diffusing angle without in the micro lenses and orientation is eliminated since the energy diffuses from the center to the sides.

Accordingly, the present invention provides a composite light guiding curved surface structure capable of increasing the diffusing angle and the light-receiving efficiency. Therefore, the present invention is useful, novel and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A composite light guiding curved surface structure, comprising:
a structure body comprising a light-receiving surface being provided with a plurality of curved surfaces thereon, each curved surface being provided with a plurality of micro lenses thereon, each micro lens being provided with a plurality of sub-wavelength anti-reflecting structures thereon; and
at least one light source disposed on one side of the light-receiving surface to generate a light field projecting onto the light-receiving surface.

2. The composite light guiding curved surface structure as recited in claim 1, wherein the structure body is a direct-type light guide plate.

3. The composite light guiding curved surface structure as recited in claim 1, wherein the structure body is an edge-type light guide plate.

4. The composite light guiding curved surface structure as recited in claim 1, wherein the structure body is an edge-type light guide bar.

5. The composite light guiding curved surface structure as recited in claim 1, wherein the micro lens has an arc-surfaced structure, a cone-surfaced structure or combination thereof.

6. The composite light guiding curved surface structure as recited in claim 1, wherein the sub-wavelength anti-reflecting structures are arranged in an array.

7. The composite light guiding curved surface structure as recited in claim 1, wherein the sub-wavelength anti-reflecting structures are arranged irregularly.

8. The composite light guiding curved surface structure as recited in claim 1, wherein the sub-wavelength anti-reflecting structures are gratings, holes, columns, cones or combination thereof.

9. The composite light guiding curved surface structure as recited in claim 1, further comprising a light-emitting surface being provided with a plurality of micro structures thereon.

10. The composite light guiding curved surface structure as recited in claim 9, wherein the micro structures gratings.
